(19) United States
(12) Patent Application Publication
(10) Pub. No.: US 2025/0193760 A1
(43) Pub. Date: Jun. 12, 2025

(54) METHODS AND APPARATUSES FOR A PSCELL CHANGE OR CPAC PROCEDURE

(71) Applicant: LENOVO (BEIJING) LIMITED, Beijing (CN)

(72) Inventors: Le Yan, Shanghai (CN); Mingzeng Dai, Shanghai (CN); Lianhai Wu, Beijing (CN); Congchi Zhang, Shanghai (CN); Yibin Zhuo, Shanghai (CN)

(21) Appl. No.: 18/856,267

(22) PCT Filed: Apr. 14, 2022
(86) PCT No.: PCT/CN2022/086838

§ 371 Date: Oct. 11, 2024

(51) Int. Cl. H04W 36/30; H04W 36/00

(52) U.S. Cl. CPC H04W 36/305; H04W 36/0069

(57) ABSTRACT

Embodiments of the present application relate to methods and apparatuses for a primary secondary cell group cell (PSCell) change procedure or a conditional PSCell addition and change (CPAC) procedure. According to an embodiment of the present application, a user equipment (UE) includes a transceiver and a processor coupled to the transceiver; and the processor is configured: in response to fulfilling a trigger condition, to generate first information associated with a successful completion of a primary secondary cell group cell (PSCell) change procedure or a conditional PSCell addition and change (CPAC) procedure, wherein the UE switches from a source PSCell to a target PSCell during the PSCell change procedure or the CPAC procedure; and to transmit the first information via the transceiver to a master node (MN) or a target secondary node (SN) which manages the target PSCell.

### TECHNICAL FIELD

Embodiments of the present application generally relate to wireless communication technology, especially to methods and apparatuses for a primary secondary cell group cell (PSCell) change procedure or a conditional PSCell addition and change (CPAC) procedure.

### BACKGROUND

Next generation radio access network (NG-RAN) supports a multi-radio dual connectivity (MR-DC) operation. In a MR-DC scenario, a user equipment (UE) with multiple transceivers may be configured to utilize resources provided by two different nodes connected via non-ideal backhauls. One node may provide new radio (NR) access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, Xn interface or X2 interface as specified in 3rd Generation Partnership Project (3GPP) standard documents), and at least the MN is connected to the core network.

Currently, in a 3GPP LTE system or 5G system, details regarding a mobility robustness optimization (MRO) mechanism for a PSCell change procedure or a CPAC procedure in a MR-DC scenario have not been discussed yet.

### SUMMARY

Some embodiments of the present application provide a user equipment (UE). The UE includes a transceiver and a processor coupled to the transceiver; and the processor is configured: in response to fulfilling a trigger condition, to generate first information associated with a successful completion of a primary secondary cell group cell (PSCell) change procedure or a conditional PSCell addition and change (CPAC) procedure, wherein the UE switches from a source PSCell to a target PSCell during the PSCell change procedure or the CPAC procedure; and to transmit the first information via the transceiver to a master node (MN) or a target secondary node (SN) which manages the target PSCell.

In some embodiments, the processor of the UE is configured: to generate second information associated with a secondary cell group (SCG) failure; and to transmit the second information via the transceiver to the MN.

In some embodiments, at least one of the first information or the second information includes at least one of: a cell radio network temporary identifier (C-RNTI) of the source PSCell; a C-RNTI of the target PSCell; first time information related to the first information; second time information related to the second information; or an indication for indicating whether both the first information and the second information are associated with the PSCell change procedure or the CPAC procedure.

In some embodiments, the first time information includes at least one of: first absolute time when the first information is generated; second absolute time when an RRC message for the PSCell change procedure or the CPAC procedure is received by the UE; or a time duration from the second absolute time to the first absolute time.

In some embodiments, the second time information includes at least one of: third absolute time when the second information is generated; a time duration from the second absolute time to the third absolute time; or a time duration from the first absolute time to the third absolute time.

In some embodiments, the trigger condition is one of: the first information is generated when a ratio between a value of elapsed running time of timer T312 related to a first measurement frequency or identity or object of the target PSCell and a configured value of the timer T312 is longer than a first threshold; and the first information is generated when a ratio between a value of elapsed running time of timer T312 related to a second measurement frequency or identity or object and a configured value of the timer T312 is longer than a second threshold.

In some embodiments, the first information includes at least one of: information associated with the first measurement frequency or identity or object; cell information associated with the first measurement frequency or identity or object; information associated with the second measurement frequency or identity or object; or cell information associated with the second measurement frequency or identity or object.

In some embodiments, the processor of the UE is configured to transmit an indication for indicating an optional capability for generating the first information via the transceiver to the MN.

In some embodiments, the indication is included in a UE capability information message.

Some embodiments of the present application provide a method performed by a UE. The method includes: generating first information associated with a successful completion of a primary secondary cell group cell (PSCell) change procedure or a conditional PSCell addition and change (CPAC) procedure, wherein the UE switches from a source PSCell to a target PSCell during the PSCell change procedure or the CPAC procedure; and transmitting the first information to a master node (MN).

Some embodiments of the present application also provide a master node (MN). The MN includes a transceiver and a processor coupled to the transceiver; and the processor is configured: to transmit a radio resource control (RRC) message for a primary secondary cell group cell (PSCell) change procedure or a conditional PSCell addition and change (CPAC) procedure via the transceiver to a user equipment (UE); and to receive first information associated with a successful completion of the PSCell change procedure or the CPAC procedure via the transceiver from the UE, wherein the UE switches from a source PSCell to a target PSCell during the PSCell change procedure or the CPAC procedure.

In some embodiments, in response to the first information being generated when a ratio between a value of elapsed running time of timer T312 related to a first measurement frequency or identity or object of the target PSCell and a configured value of the timer T312 is longer than a first threshold, the first information includes at least one of: information associated with the first measurement frequency or identity or object, or cell information associated with the first measurement frequency or identity or object; and in response to the first information being generated when a ratio between a value of elapsed running time of timer T312 related to a second measurement frequency or identity or object and a configured value of the timer T312 is longer than a second threshold, the first information includes at least one of: information associated with the second measurement frequency or identity or object, or cell information associated with the second measurement frequency or identity or object.

In some embodiments, the processor of the MN is configured to transmit the first information via the transceiver to at least one of: a source secondary node (SN) which manages the source PSCell, or a target SN which manages the target PSCell.

In some embodiments, the processor of the MN is configured to receive second information associated with a secondary cell group (SCG) failure via the transceiver from the UE.

In some embodiments, the processor of the MN is configured to transmit the second information via the transceiver to at least one of: a source secondary node (SN) which manages the source PSCell, or a target SN which manages the target PSCell.

In some embodiments, at least one of the first information or the second information includes at least one of: a cell radio network temporary identifier (C-RNTI) of the source PSCell; a C-RNTI of the target PSCell; first time information related to the first information; second time information related to the second information; or an indication for indicating whether both the first information and the second information are associated with the PSCell change procedure or the CPAC procedure.

In some embodiments, the processor of the MN is configured to identify whether both the first information and the second information are associated with the PSCell change procedure or the CPAC procedure.

In some embodiments, the processor of the MN is configured: to start a timer in response to receiving the first information; and to identify that that both the first information and the second information are associated with the PSCell change procedure or the CPAC procedure, in response to receiving the second information before an expiry of the timer.

In some embodiments, in response to identifying that both the first information and the second information are associated with the PSCell change procedure or the CPAC procedure, the processor of the MN is configured to perform at least one of: modifying a set of parameters related to the PSCell change procedure or the CPAC procedure; or transmitting a first message including both the first information and the second information via the transceiver to at least one of: a source secondary node (SN) which manages the source PSCell, or a target SN which manages the target PSCell.

In some embodiments, the processor of the MN is configured to transmit a second message via the transceiver to at least one of: a source secondary node (SN) which manages the source PSCell, or a target SN which manages the target PSCell.

In some embodiments, the second message includes at least one of: a cell radio network temporary identifier (C-RNTI) of the source PSCell; a C-RNTI of the target PSCell; first time information related to the first information; second time information related to the second information; an indication for indicating whether both the first information and the second information are associated with the PSCell change procedure or the CPAC procedure; an AP ID of the UE allocated at the MN; an AP ID of the UE allocated at the source SN; an AP ID of the UE allocated at the target SN; or an information container used to identify information related to the PSCell change procedure or the CPAC procedure.

In some embodiments, the first time information includes at least one of: first absolute time when the first information is generated; second absolute time when an RRC message for the PSCell change procedure or the CPAC procedure is received by the UE; or a time duration from the second absolute time to the first absolute time.

In some embodiments, the second time information includes at least one of: third absolute time when the second information is generated; a time duration from the second absolute time to the third absolute time; or a time duration from the first absolute time to the third absolute time.

In some embodiments, the information container is received via the transceiver from the source SN.

In some embodiments, the processor of the MN is configured to receive an indication for indicating an optional capability for generating the first information via the transceiver from the UE.

In some embodiments, the indication is included in a UE capability information message.

Some embodiments of the present application provide a method performed by a master node (MN). The method includes: transmitting a radio resource control (RRC) message for a primary secondary cell group cell (PSCell) change procedure or a conditional PSCell addition and change (CPAC) procedure to a user equipment (UE); and receiving first information associated with a successful completion of the PSCell change procedure or the CPAC procedure from the UE, wherein the UE switches from a source PSCell to a target PSCell during the PSCell change procedure or the CPAC procedure.

Some embodiments of the present application provide a source secondary node (SN). The source SN includes a transceiver and a processor coupled to the transceiver; and the processor is configured to receive first information associated with a successful completion of a primary secondary cell group cell (PSCell) change procedure or a conditional PSCell addition and change (CPAC) procedure via the transceiver from a master node (MN), wherein a user equipment (UE) switches from a source PSCell managed by the source SN to a target PSCell during the PSCell change procedure or the CPAC procedure.

In some embodiments, in response to the first information being generated when a ratio between a value of elapsed running time of timer T312 related to a first measurement frequency or identity or object of the target PSCell and a configured value of the timer T312 is longer than a first threshold, the first information includes at least one of: information associated with the first measurement frequency or identity or object, or cell information associated with the first measurement frequency or identity or object; and in response to the first information being generated when a ratio between a value of elapsed running time of timer T312 related to a second measurement frequency or identity or object and a configured value of the timer T312 is longer than a second threshold, the first information includes at least one of: information associated with the second measurement frequency or identity or object, or cell information associated with the second measurement frequency or identity or object.

In some embodiments, the processor of the source SN is configured to receive second information associated with a secondary cell group (SCG) failure via the transceiver from the MN.

In some embodiments, the first information and the second information are received in one message or two separate messages.

In some embodiments, at least one of the first information or the second information includes at least one of: a cell radio network temporary identifier (C-RNTI) of the source PSCell; a C-RNTI of the target PSCell; first time information related to the first information; second time information related to the second information; an indication for indicating whether both the first information and the second information are associated with the PSCell change procedure or the CPAC procedure; an AP ID of the UE allocated at the MN; an AP ID of the UE allocated at the source SN; an AP ID of the UE allocated at a target SN which manages the target PSCell; or an information container used to identify information related to the PSCell change procedure or the CPAC procedure.

In some embodiments, the first time information includes at least one of: first absolute time when the first information is generated; second absolute time when an RRC message for the PSCell change procedure or the CPAC procedure is received by the UE; or a time duration from the second absolute time to the first absolute time.

In some embodiments, the second time information includes at least one of: third absolute time when the second information is generated; a time duration from the second absolute time to the third absolute time; or a time duration from the first absolute time to the third absolute time.

In some embodiments, the processor of the source SN is configured to transmit the information container via the transceiver to the MN before receiving the first information.

In some embodiments, the processor of the source SN is configured to identify whether both the first information and the second information are associated with the PSCell change procedure or the CPAC procedure.

In some embodiments, the processor of the source SN is configured to modify a set of parameters related to the PSCell change procedure or the CPAC procedure, in response to identifying that both the first information and the second information are associated with the PSCell change procedure or the CPAC procedure.

Some embodiments of the present application provide a method performed by a source secondary node (SN). The method includes receiving first information associated with a successful completion of a primary secondary cell group cell (PSCell) change procedure or a conditional PSCell addition and change (CPAC) procedure from a master node (MN), wherein a user equipment (UE) switches from a source PSCell managed by the source SN to a target PSCell during the PSCell change procedure or the CPAC procedure.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned methods performed by a UE, a MN, or a source SN.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flowchart of transmitting information associated with a PSCell change or CPAC procedure in accordance with some embodiments of the present application.

FIG. 3 illustrates an exemplary flowchart of receiving information associated with a PSCell change or CPAC procedure in accordance with some embodiments of the present application.

FIG. 4 illustrates a flow chart of an exemplary procedure of wireless communications in accordance with some embodiments of the present application.

FIG. 5 illustrates a flow chart of an exemplary procedure of wireless communications in accordance with some embodiments of the present application.

FIG. 6 illustrates a flow chart of an exemplary procedure of wireless communications in accordance with some embodiments of the present application.

FIG. 7 illustrates an exemplary block diagram of an apparatus for a PSCell change or CPAC procedure in accordance with some embodiments of the present application.

FIG. 8 illustrates a further exemplary block diagram of an apparatus for a PSCell change or CPAC procedure in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

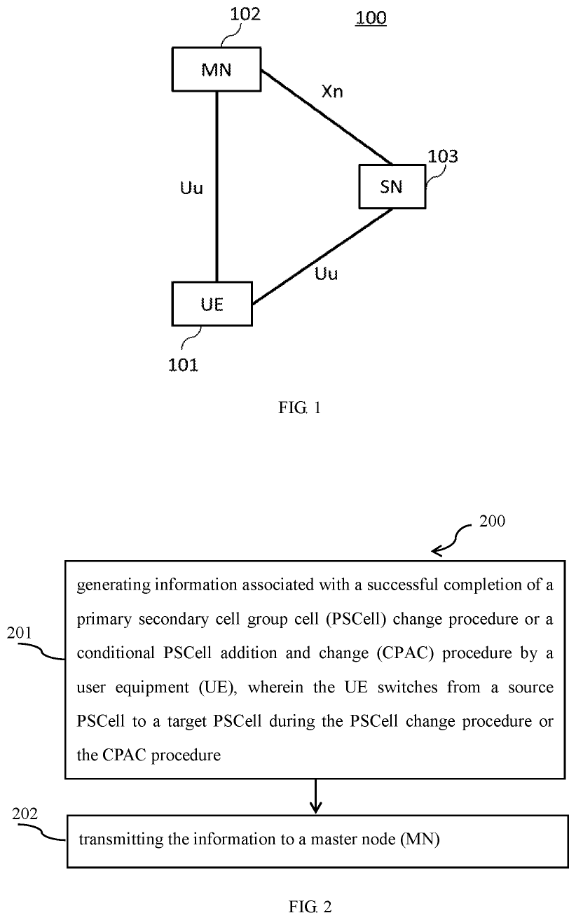

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface or the X2 interface as specified in 3GPP standard documents. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more secondary cells (SCells) of the SCG. The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

According to 3GPP standard documents, two types of SN or PSCell change procedures are supported: a MN initiated SN or PSCell change procedure; or a SN initiated SN or PSCell change procedure. The “SN or PSCell change” means SN/PSCell change in any MR-DC cases, which includes LTE-LTE DC, NR-NR DC, EN-DC, NGEN-DC, and NE-DC. A MN initiated SN/PSCell change procedure is used to transfer a UE context from the source SN to a target SN and to change the SCG configuration in UE from one SN to another. For SCG, in MR-DC, a group of serving cells associated with the SN, comprising of the SpCell (PSCell) and optionally one or more SCells. The SN/PSCell change procedure always involves signalling over MCG SRB towards the UE. For MCG, in MR-DC, a group of serving cells associated with the Master Node, comprising of the SpCell (PCell) and optionally one or more SCells. A SN initiated SN/PSCell change procedure is used to transfer a UE context from the source SN to a target SN and to change the SCG configuration in UE from one SN to another.

Currently, a conditional PSCell addition (CPA) procedure and conditional PSCell change (CPC) procedure are supported. According to agreements of 3GPP standard documents, a conditional PSCell addition and change (CPAC) procedure is defined as a PSCell addition or change that is executed by a UE when execution condition(s) is met. A CPA procedure or a CPC procedure is an example of a CPAC procedure. A UE starts evaluating the execution condition(s) for at least one candidate PSCell upon receiving an RRC message for the CPAC procedure, e.g., the UE starts evaluating the execution condition(s) for at least one candidate PSCell upon receiving CPAC configuration information that is included in the RRC message, and stops evaluating the execution condition(s) once a PSCell addition procedure and/or a PSCell change procedure is triggered.

A successful PSCell change report (e.g., SPC-report) would be introduced in the future 3GPP Release, to optimize PSCell change or CPAC related parameters, e.g., if a physical layer issue is detected by the UE during an ongoing PSCell change or CPAC procedure. For successful PSCell change report reporting, configuration(s) for a UE to report the successful PSCell change (e.g., successPSCellChange-Config IE) is sent from the network, e.g., the network sends configuration(s) associated with trigger condition(s) for SPC-report to the UE. Based on the network configuration, a UE needs to log/generate/store/record successful PSCell change related parameters or successful CPAC related parameters when one or more trigger condition(s) is satisfied. The trigger condition can include at least one of the following:
(1) radio problem(s) in a source PSCell, e.g., elapsed running time of timer T310 and/or T312 for source SCG is longer than a configured threshold;
(2) radio problem(s) in a source PCell, e.g., elapsed running time of timer T310 and/or T312 for source MCG is longer than a configured threshold;
(3) radio problem(s) in a target PSCell, e.g., elapsed running time of timer T310 and/or T312 for target SCG is longer than a configured threshold;
(4) elapsed running time of timer T3104 is longer than a configured threshold; or
(5) beam failure(s) is detected in source MCG, source SCG, and/or target SCG.

A successful PSCell change report can be generated, logged, and/or stored to the network, including cell information of the source PSCell, cell information of the target PSCell, cause value for successful PSCell change report, and/or measurement result(s). Cell information can be represented by global cell identity and tracking area code, and/or, PCI and carrier frequency.

Currently, a purpose of a SCG failure information procedure is to inform E-UTRAN or NR MN about a SCG failure the UE has experienced, i.e., a SCG radio link failure, a failure of SCG reconfiguration with sync, a SCG configuration failure for an RRC message on signalling radio bearer (SRB) 3, a SCG integrity check failure, and a consistent uplink LBT failures on PSCell for operation with shared spectrum channel access. Failure type, measurement result(s) in MCG, and/or measurement result(s) in SCG can be included in a SCG failure information message. After the network receives the SCG failure information message, it can trigger the UE to perform a SN release or modification or change procedure. The following information can be included in the SCG failure information message in case of a SCG failure: previous PSCell ID (i.e., PCI); failed PSCell ID (i.e., PCI); time SCG failure; RA-Information; and/or failure type.

Currently, a network may initiate a UE capability transfer procedure to a UE in an RRC_CONNECTED state when it needs (additional) UE radio access capability information. The network should retrieve UE capabilities only after AS security activation, e.g., via a UE capability enquiry message. The network does not forward UE capabilities that were retrieved before AS security activation to the core network (CN). The UE compiles and transfers its UE capability information upon receiving a UE capability enquiry message from the network, e.g., via a UE capability information message.

Currently, there is no mechanism for a MRO purpose for a PSCell change or CPAC procedure in a MR-DC scenario. To resolve the abovementioned problems, embodiments of the present application provide a MRO function for a PSCell change or CPAC procedure.

More specifically, some embodiments of the present application introduce an optional UE capability with signalling for a successful PSCell change report. In some embodiments of the present application, to identify whether SPC-report and SCG failure information concern the same PSCell change or CPAC procedure, at least one of the following information is included in Xn message or X2 message when transferring the SPC-report and/or the SCG failure information from a MN to S-SN and/or T-SN: (1) C-RNTI of source PSCell; (2) C-RNTI of target PSCell; (3) time information (e.g., including absolute timestamp when SPC-report is generated, logged, and/or stored; or time elapsed from the time of receiving PSCell change/CPAC command to the SPC-report is generated, logged, and/or stored; absolute timestamp when SCG failure information is generated, logged, and/or stored; or time elapsed from the time when SPC-report is generated, logged, and/or stored to the time when SCG failure information is generated, logged, and/or stored); (4) UE AP ID allocated at MN, UE AP ID allocated at source SN, and/or UE AP ID allocated at target SN; (5) a container (e.g., implementation dependent) used to map with UE context related to PSCell change or CPAC procedure, or used to identify information related to the PSCell change procedure or the CPAC procedure, e.g., the container can be named as PSCell change mobility information; and/or (6) one indication to indicate that the SPC-report and the SCG failure information are for the same PSCell change or CPAC procedure.

In some embodiments of the present application, after a MN receives SPC-report, the MN starts a timer. If the SCG failure information is received before an expiry of the timer, the MN can understand that the SPC-report and the SCG failure information are correlated. In an embodiment, e.g., for a SN initiated PSCell change or CPAC procedure, the MN uses the same message to send the received information within SPC-report and SCG failure information to a source SN and/or a target SN. More details regarding the embodiments of the present application will be illustrated in the following text in combination with the appended drawings.

FIG. 2 illustrates an exemplary flowchart of transmitting information associated with a PSCell change or CPAC procedure in accordance with some embodiments of the present application. The exemplary method 200 in the embodiments of FIG. 2 may be performed by a UE, e.g., UE 101 as shown in FIG. 1. Although described with respect to a UE, it should be understood that other devices may be configured to perform a method similar to that of FIG. 2.

In the exemplary method 200 as shown in FIG. 2, in operation 201, in response to fulfilling a trigger condition, a UE generates, logs, and/or stores information associated with a successful completion of a PSCell change procedure or a CPAC procedure (which is named as “1st information” for simplicity). The UE may switch from a source PSCell to a target PSCell during the PSCell change procedure or the CPAC procedure. In operation 202, the UE transmits the 1st information to a MN (e.g., MN 102 as shown in FIG. 1). For example, the UE transmits SPC-report to the MN in operation 202 when a PSCell change or CPAC procedure is successful, e.g., via the UE information response message. Specific examples are described in embodiments of FIGS. 4-6 as follows.

In some embodiments, the UE generates information associated with a SCG failure (which is named as “2nd information” for simplicity), and transmits the 2nd information to the MN. For example, the UE transmits SCG failure information to the MN when a SCG failure happens shortly after the successful PSCell change or CPAC, via the SCG failure information message, after transmitting the SPC-report. Specific examples are described in embodiments of FIGS. 4-6 as follows.

In some embodiments, the 1st information and/or the 2nd information includes:
(1) C-RNTI of the source PSCell of the UE;
(2) a C-RNTI of the target PSCell of the UE;
(3) a C-RNTI of the PCell of the UE;
(4) time information related to the 1st information;
(5) time information related to the 2nd information; and/or
(6) an indication for indicating whether both the 1st information and the 2nd information are associated with the PSCell change procedure or the CPAC procedure, i.e., whether the 1st information and the 2nd information are associated with the same PSCell change or CPAC procedure.

In some embodiments, the time information related to the 1st information includes:
(1) absolute time when the 1st information is generated (which is named as “1st absolute time” for simplicity);
(2) absolute time when an RRC message for the PSCell change procedure or the CPAC procedure (e.g., including configuration(s) associated with the PSCell change or CPAC procedure) is received by the UE (which is named as “2nd absolute time” for simplicity); and/or
(3) a time duration from the 2nd absolute time to the 1st absolute time.

In some embodiments, the time information related to the 2nd information includes:
(1) absolute time when the 2nd information is generated (which is named as “3rd absolute time” for simplicity);
(2) a time duration from the 2nd absolute time to the 3rd absolute time; and/or
(3) a time duration from the 1st absolute time to the 3rd absolute time.

In some embodiments, the trigger condition for the UE to generate the 1st information in operation 201 may be configured as one of:
(1) the 1st information is generated when elapsed running time of timer T312 related to a measurement frequency or a measurement identity or a measurement object that is associated with the target PSCell is longer than a threshold, or, the 1st information is generated when a ratio between a value of elapsed running time of timer T312 related to a measurement frequency or a measurement identity or a measurement object of the target PSCell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312).
(2) the 1st information is generated when elapsed running time of any timer T312 related to a measurement frequency or a measurement identity or a measurement object that is configured to the UE is longer than a threshold, or, the 1st information is generated when a ratio between a value of elapsed running time of timer T312 related to a measurement frequency or a measurement identity or a measurement object of any cell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312).
(3) the 1st information is generated when elapsed running time of timer T310 related to a measurement frequency or a measurement identity or a measurement object that is associated with the target PSCell is longer than a threshold, or, the 1st information is generated when a ratio between a value of elapsed running time of timer T310 related to a measurement frequency or a measurement identity or a measurement object of the target PSCell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310).
(4) the 1st information is generated when elapsed running time of any timer T310 related to a measurement frequency or a measurement identity or a measurement object that is configured to the UE is longer than a threshold, or, the 1st information is generated when a ratio between a value of elapsed running time of timer T310 related to a measurement frequency or a measurement identity or a measurement object of any cell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310).
(5) the 1st information is generated when elapsed running time of timer T304 related to the target PSCell is longer than a threshold, or, the 1st information is generated when a ratio between a value of elapsed running time of timer T304 related to the target PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304).
(6) the 1st information is generated when elapsed running time of any timer T304 related to a candidate PSCell that is configured to the UE is longer than a threshold, or, the 1st information is generated when a ratio between a value of elapsed running time of timer T304 related to any candidate PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304).

In some embodiments, the 1st information includes:
(1) information associated with the measurement frequency or identity or object that is associated with the target PSCell, e.g., measurement frequency or identity or object of the target PSCell;
(2) cell information associated with the measurement frequency or identity or object that is associated with the target PSCell, e.g., global cell identity and tracking area code, and/or, PCI and carrier frequency (e.g., Absolute Radio Frequency Channel Number (ARFCN)) of the target PSCell;
(3) information associated with the measurement frequency or identity or object that is configured to the UE, e.g., measurement frequency or identity or object of any cell that configured by the network to the UE for RRM measurement; and/or
(4) cell information associated with the measurement frequency or identity or object that is configured to the UE, e.g., global cell identity and tracking area code, and/or, PCI and carrier frequency (e.g., Absolute Radio Frequency Channel Number (ARFCN)) of any cell that configured by the network to the UE for RRM measurement.

In some embodiments, the UE transmits “an indication for indicating an optional capability for generating the 1st information” to the MN. In an embodiment, the indication is included in a UE capability information message. In a specific embodiment (named as Embodiment 1 for simplicity), regarding the UE's capability for logging, generating, and/or storing successful PSCell change related information, there may be three potential options:
(1) Option 1: Mandatory support without capability signalling. The UE should support logging of successful PSCell change related information, if the UE supports a PSCell change or CPAC procedure.
(2) Option 2: Optional support with capability signalling. Logging of successful PSCell change related information is optional, even if the UE supports a PSCell change or CPAC procedure. This capability is explicitly signalled to the network (e.g., the MN and the SN). For example, explicit capability signalling is needed for SPC-report, and the UE indicates an optional capability for generating successful PSCell change related information to the network (e.g., the MN and the SN).
(3) Option 3: Optional support without capability signalling. Logging of successful PSCell change related information is optional, even if the UE supports a PSCell change or CPAC procedure. No explicit capability bit is signalled to the network.

In Embodiment 1, since there is an additional requirement for a UE to log, generate, or store successful PSCell change related information (e.g., SPC-report), the best way is Option 2 that a UE capability indication for SPC-report is needed, i.e., introducing optional UE capability for SPC-report.

In legacy, explicit capability signalling for one feature is used when it is needed for the network to know the UE capability. Thus, the network can perform corresponding behaviour(s), e.g., configuring parameters to the UE to support this feature. Since pre-configuration for the UE to report the successful PSCell change is required (e.g., “successPSCellChange-Config” IE), the network needs to know the UE capability explicitly in order to configure proper configuration to trigger successful PSCell change report logging.

In Embodiment 1, the best way is Option 2 which introduces an optional UE capability with signalling for SPC-report, e.g., including an optional UE capability indication for SPC-report, e.g., an optional UE capability indication for SPC-report can be included in a UECapabilityInformation message. Specific examples are described in operations 410A, 410B, 510A, 510B, 610A, or 610B of the embodiments of FIGS. 4-6 as follows.

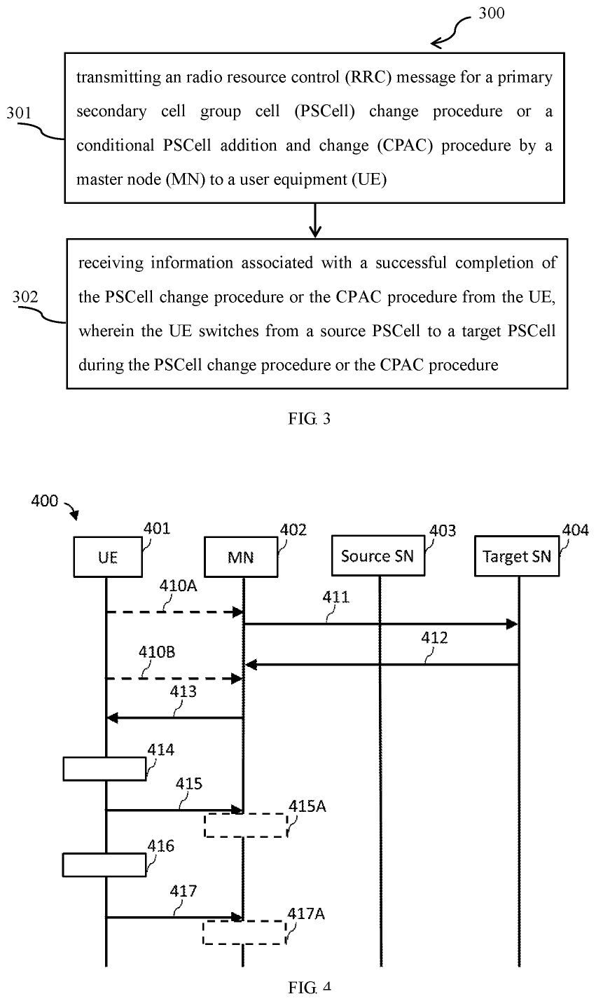

FIG. 3 illustrates an exemplary flowchart of receiving information associated with a PSCell change or CPAC procedure in accordance with some embodiments of the present application. The exemplary method 300 in the embodiments of FIG. 3 may be performed by a MN, e.g., MN 102 as shown in FIG. 1. Although described with respect to a MN, it should be understood that other devices may be configured to perform a method similar to that of FIG. 3.

In the exemplary method 300 as shown in FIG. 3, in operation 301, a MN transmits an RRC message for a PSCell change procedure or a CPAC procedure (e.g., including configuration(s) associated with the PSCell change or CPAC procedure) to a UE (e.g., UE 101 as shown in FIG. 1). In operation 302, the MN receives information (e.g., the 1st information) associated with a successful completion of the PSCell change procedure or the CPAC procedure from the UE, e.g., the 1st information may be included an RRC message sent by the UE, e.g., a UE information response message. The UE may switch from a source PSCell to a target PSCell during the PSCell change procedure or the CPAC procedure.

In some embodiments, in a case that the 1st information is generated when elapsed running time of timer T312 related to “a measurement frequency or identity or object that is associated with the target PSCell” is longer than a threshold, or in a case that the 1st information is generated when a ratio between a value of elapsed running time of timer T312 related to a measurement frequency or a measurement identity or a measurement object of the target PSCell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312), the 1st information includes: information associated with “the measurement frequency or identity or object that is associated with the target PSCell”; and/or cell information associated with “the measurement frequency or identity or object that is associated with the target PSCell”.

In a case that the 1st information is generated when elapsed running time of any timer T312 related to “a measurement frequency or identity or object that is configured to the UE” is longer than a threshold, or in a case that the 1st information is generated when a ratio between a value of elapsed running time of timer T312 related to a measurement frequency or a measurement identity or a measurement object of any cell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312), the 1st information includes: information associated with “the measurement frequency or identity or object that is configured to the UE”; and/or cell information associated with “the measurement frequency or identity or object that is configured to the UE”.

In a case that the 1st information is generated when elapsed running time of timer T310 related to a measurement frequency or a measurement identity or a measurement object that is associated with the target PSCell is longer than a threshold, or, in a case that the 1st information is generated when a ratio between a value of elapsed running time of timer T310 related to a measurement frequency or a measurement identity or a measurement object of the target PSCell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310), the 1st information includes: information associated with “the measurement frequency or identity or object that is associated with the target PSCell”; and/or cell information associated with “the measurement frequency or identity or object that is associated with the target PSCell”.

In a case that the 1st information is generated when elapsed running time of any timer T310 related to a measurement frequency or a measurement identity or a measurement object that is configured to the UE is longer than a threshold, or, in a case that the 1st information is generated when a ratio between a value of elapsed running time of timer T310 related to a measurement frequency or a measurement identity or a measurement object of any cell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310), the 1st information includes: information associated with “the measurement frequency or identity or object that is configured to the UE”; and/or cell information associated with “the measurement frequency or identity or object that is configured to the UE”.

In a case that the 1st information is generated when elapsed running time of timer T304 related to the target PSCell is longer than a threshold, or, in a case that the 1st information is generated when a ratio between a value of elapsed running time of timer T304 related to the target PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304), the 1st information includes cell information associated with the target PSCell.

In a case that the 1st information is generated when elapsed running time of any timer T304 related to a candidate PSCell that is configured to the UE is longer than a threshold, or, in a case that the 1st information is generated when a ratio between a value of elapsed running time of timer T304 related to any candidate PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304), the 1st information includes cell information associated with the candidate PSCell.

In some embodiments, the MN transmits the 1st information to a source SN which manages the source PSCell, e.g., via a X2 or Xn message, and/or MN transmits the 1st information to a target SN which manages the target PSCell, e.g., via a X2 or Xn message.

In some embodiments, the MN receives information associated with a SCG failure (e.g., the 2nd information) from the UE, e.g., the 2nd information may be included an RRC message sent by the UE, e.g., a SCG failure information message. In some embodiments, the MN transmits the 2nd information to a source SN which manages the source PSCell, e.g., via a X2 or Xn message, and/or the MN transmits the 2nd information to a target SN which manages the target PSCell, e.g., via a X2 or Xn message.

In some other embodiments, the 1st information includes at least one of: cell information of the source PSCell, cell information of the target PSCell, cause value for successful PSCell change report, and/or measurement result(s) of the UE. For instance, the cell information of the source PSCell or the cell information of the target PSCell can be represented by global cell identity and tracking area code, and/or, PCI and carrier frequency.

In some other embodiments, the 2nd information includes at least one of: a previous PSCell ID (e.g., PCI) of the UE; a failed PSCell ID (e.g., PCI) of the UE; a time SCG failure of the UE; RA-Information of the UE; and/or a failure type of the SCG failure.

In some embodiments, the 1st information and/or the 2nd information may also include:
(1) a C-RNTI of the source PSCell of the UE;
(2) a C-RNTI of the target PSCell of the UE;
(3) a C-RNTI of the PCell of the UE;
(4) time information related to the 1st information;
(5) time information related to the 2nd information; and/or
(6) an indication for indicating whether both the 1st information and the 2nd information are associated with the PSCell change procedure or the CPAC procedure.

In some embodiments, the MN identifies whether both the 1st information and the 2nd information are associated with the PSCell change procedure or the CPAC procedure. In an embodiment, the MN starts a timer in response to receiving the 1st information. In response to receiving the 2nd information before an expiry of the timer, the MN identifies that that both the 1st information and the 2nd information are associated with a same PSCell change procedure or the CPAC procedure. A specific example is described in embodiments of FIG. 4 as follows.

In some embodiments, in response to identifying that both the 1st information and the 2nd information are associated with the PSCell change procedure or the CPAC procedure, the MN may: modify parameter(s) related to the PSCell change procedure or the CPAC procedure, based on based on the received 1st information and 2nd information; and/or, transmit a message including both the 1st information and the 2nd information to a source SN which manages the source PSCell and/or a target SN which manages the target PSCell.

In some embodiments, the MN transmits a message to a source SN which manages the source PSCell and/or a target SN which manages the target PSCell. In an embodiment, this message includes:
(1) a C-RNTI of the source PSCell of the UE;
(2) a C-RNTI of the target PSCell of the UE;
(3) a C-RNTI of the PCell of the UE;
(4) time information related to the 1st information;
(5) time information related to the 2nd information;
(6) an indication for indicating whether both the 1st information and the 2nd information are associated with the PSCell change procedure or the CPAC procedure;
(7) an AP ID of the UE (e.g., XnAP ID, X2AP ID) allocated at the MN;
(8) an AP ID of the UE (e.g., XnAP ID, X2AP ID) allocated at the source SN;
(9) an AP ID of the UE (e.g., XnAP ID, X2AP ID) allocated at the target SN;
(10) an information container used to identify information related to the PSCell change procedure or the CPAC procedure. In an embodiment, the information container is received by the MN from the source SN. A specific example is described in Step 511 in FIG. 5.
(11) cell information of the source PSCell, global cell identity and tracking area code, and/or, PCI and carrier frequency (e.g., ARFCN) of the source PSCell;
(12) cell information of the target PSCell, global cell identity and tracking area code, and/or, PCI and carrier frequency (e.g., ARFCN) of the target PSCell;
(13) cause value for successful PSCell change report;
(14) measurement result(s) of the UE;
(15) a previous PSCell ID (e.g., PCI) of the UE;
(16) a failed PSCell ID (e.g., PCI) of the UE;
(17) a time duration from receiving SCG change command to SCG failure;
(18) RA-Information of the UE; and/or
(19) a failure type of the SCG failure.

In some embodiments, the time information related to the 1st information includes:
(1) absolute time when the 1st information is generated (e.g., 1st absolute time);
(2) absolute time when an RRC message for the PSCell change procedure or the CPAC procedure is received by the UE (e.g., 2nd absolute time); and/or
(3) a time duration from the 2nd absolute time to the 1st absolute time.

In some embodiments, the time information related to the 2nd information includes:
(1) absolute time when the 2nd information is generated (e.g., 3rd absolute time);
(2) a time duration from the 2nd absolute time to the 3rd absolute time; and/or
(3) a time duration from the 1st absolute time to the 3rd absolute time.

In some embodiments, the MN receives an indication for indicating an optional capability for generating the 1st information from the UE. In an embodiment, the indication is included in a UE capability information message. Specific examples are described in Embodiment 1 and operations 410A, 410B, 510A, 510B, 610A, or 610B of the embodiments of FIGS. 4-6 as follows.

It should be appreciated by persons skilled in the art that the sequence of the operations in exemplary procedure 200 or 300 may be changed and some of the operations in exemplary procedure 200 or 300 may be eliminated or modified, without departing from the spirit and scope of the disclosure. Details described in all other embodiments of the present application (for example, details regarding information associated with a successful completion of a PSCell change or CPAC procedure) are applicable for the embodiments of FIG. 2 or FIG. 3. Moreover, details described in the embodiments of FIG. 2 or FIG. 3 are applicable for all the embodiments of FIGS. 1 and 4-8.

In addition, some embodiments of the present application provide an exemplary flowchart of receiving information associated with a successful completion of a PSCell change or CPAC procedure, which may be performed by a source SN (e.g., SN 103 as shown in FIG. 1). Although described with respect to a source SN, it should be understood that other devices may be configured to perform a similar method.

It should be appreciated by persons skilled in the art that the sequence of the operations in this exemplary flowchart of a source SN may be changed and some of the operations in this exemplary flowchart may be eliminated or modified, without departing from the spirit and scope of the disclosure. Details described in all other embodiments of the present application, e.g., in the embodiments of FIGS. 2 and 3 are applicable for this exemplary flowchart. Moreover, details described in this exemplary flowchart are applicable for all the embodiments of FIGS. 1-8.

In particular, in this exemplary flowchart, a source SN (e.g., SN 103 as shown in FIG. 1) receives information associated with a successful completion of a PSCell change procedure or a CPAC procedure (e.g., the 1st information) from a MN (e.g., MN 102 as shown in FIG. 1). A UE (e.g., UE 101 as shown in FIG. 1) may switch from a source PSCell managed by the source SN to a target PSCell (e.g., a SN not shown in FIG. 1) during the PSCell change procedure or the CPAC procedure.

In some embodiments, in a case that the 1st information is generated when elapsed running time of timer T312 related to “a measurement frequency or identity or object associated with the target PSCell” is longer than a threshold, or in a case that the 1st information is generated when a ratio between a value of elapsed running time of timer T312 related to a measurement frequency or a measurement identity or a measurement object of the target PSCell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312), the 1st information includes: information associated with “the measurement frequency or identity or object associated with the target PSCell”; and/or cell information associated with “the measurement frequency or identity or object associated with the target PSCell”.

In a case that the 1st information is generated when elapsed running time of any timer T312 related to “a measurement frequency or identity or object configured to the UE” is longer than a threshold, or in a case that the 1st information is generated when a ratio between a value of elapsed running time of timer T312 related to a measurement frequency or a measurement identity or a measurement object of any cell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312), the 1st information includes: information associated with “the measurement frequency or identity or object configured to the UE”; and/or cell information associated with “the measurement frequency or identity or object configured to the UE”.

In a case that the 1st information is generated when elapsed running time of timer T310 related to a measurement frequency or a measurement identity or a measurement object that is associated with the target PSCell is longer than a threshold, or, in a case that the 1st information is generated when a ratio between a value of elapsed running time of timer T310 related to a measurement frequency or a measurement identity or a measurement object of the target PSCell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310), the 1st information includes: information associated with “the measurement frequency or identity or object associated with the target PSCell”; and/or cell information associated with “the measurement frequency or identity or object associated with the target PSCell”.

In a case that the 1st information is generated when elapsed running time of any timer T310 related to a measurement frequency or a measurement identity or a measurement object that is configured to the UE is longer than a threshold, or, in a case that the 1st information is generated when a ratio between a value of elapsed running time of timer T310 related to a measurement frequency or a measurement identity or a measurement object of any cell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310), the 1st information includes: information associated with “the measurement frequency or identity or object configured to the UE”; and/or cell information associated with “the measurement frequency or identity or object configured to the UE”.

In a case that the 1st information is generated when elapsed running time of timer T304 related to the target PSCell is longer than a threshold, or, in a case that the 1st information is generated when a ratio between a value of elapsed running time of timer T304 related to the target PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304), the 1st information includes cell information associated with the target PSCell.

In a case that the 1st information is generated when elapsed running time of any timer T304 related to a candidate PSCell that is configured to the UE is longer than a threshold, or, in a case that the 1st information is generated when a ratio between a value of elapsed running time of timer T304 related to any candidate PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304), the 1st information includes cell information associated with the candidate PSCell.

In some embodiments, the source SN receives information associated with a SCG failure (e.g., the 2nd information) from the MN. The 1st information and the 2nd information may be received in one message or two separate messages.

In some embodiments, the 1st information and/or the 2nd information includes at least one of:
(1) a C-RNTI of the source PSCell of the UE;
(2) a C-RNTI of the target PSCell of the UE;
(3) a C-RNTI of the PCell of the UE;
(4) time information related to the 1st information;
(5) time information related to the 2nd information;
(6) an indication for indicating whether both the 1st information and the 2nd information are associated with the PSCell change procedure or the CPAC procedure;
(7) an AP ID of the UE (e.g., XnAP ID, X2AP ID) allocated at the MN;
(8) an AP ID of the UE (e.g., XnAP ID, X2AP ID) allocated at the source SN;
(9) an AP ID of the UE (e.g., XnAP ID, X2AP ID) allocated at a target SN which manages the target PSCell;
(10) an information container used to identify information related to the PSCell change procedure or the CPAC procedure. In some embodiments, the source SN transmits the information container to the MN before receiving the 1st information;
(11) cell information of the source PSCell, global cell identity and tracking area code, and/or, PCI and carrier frequency (e.g., ARFCN) of the source PSCell;
(12) cell information of the target PSCell, global cell identity and tracking area code, and/or, PCI and carrier frequency (e.g., ARFCN) of the target PSCell;
(13) cause value for successful PSCell change report;
(14) measurement result(s) of the UE;
(15) a previous PSCell ID (e.g., PCI) of the UE;
(16) a failed PSCell ID (e.g., PCI) of the UE;
(17) a time duration from receiving SCG change command to SCG failure;
(18) RA-Information of the UE; and/or
(19) a failure type of the SCG failure.

In some embodiments, the time information related to the 1st information includes:
(1) absolute time when the 1st information is generated (e.g., 1st absolute time);
(2) absolute time when an RRC message for the PSCell change procedure or the CPAC procedure is received by the UE (e.g., 2nd absolute time); and/or
(3) a time duration from the 2nd absolute time to the 1st absolute time.

In some embodiments, the time information related to the 2nd information includes:
(1) absolute time when the 2nd information is generated (e.g., 3rd absolute time);
(2) a time duration from the 2nd absolute time to the 3rd absolute time; and/or
(3) a time duration from the 1st absolute time to the 3rd absolute time.

In some embodiments, the source SN identifies whether both the 1st information and the 2nd information are associated with a same PSCell change procedure or the CPAC procedure. If yes, the source SN may modify parameter(s) related to the PSCell change procedure or the CPAC procedure, based on the received 1st information and 2nd information.

In some embodiments of the present application, for a PSCell change or CPAC procedure which is initiated by a MN or SN, there may be following two cases for such procedure:
(1) Case 1: A SCG failure occurs shortly after the successful PSCell change or CPAC procedure. In this case, there is a possibility that both SPC-report and SCG failure information are generated and transmitted to the network, i.e., SPC-report may be generated when the triggering condition for SCP-report configured by the network is fulfilled, and SCG failure information is generated due to an RLF occurs shortly in the target PSCell after successful PSCell change or CPAC.
(2) Case 2: A SCG change failure occurs during an intra-SN PSCell change procedure after a successful inter-SN PSCell change procedure. In this case, the network may also receive SPC-report and SCG failure information, but the SPC-report is for the successful inter-SN PSCell change procedure, while SCG failure information is for the failed intra-SN PSCell change procedure.

Currently, the network cannot identify whether the SPC-report and SCG failure information are generated for the same PSCell change or CPAC procedure or not. For example, source PSCell CGI and target PSCell CGI are included in the SPC-report, whereas previous PSCell PCI and failed PSCell PCI are included in SCG failure information. However, current information included in these two messages cannot be directly used to identify whether these two messages are for the same PSCell change/CPAC procedure or not. Even with PCI in SPC-report, the issue also exists, since cells may have the same PCI. It is necessary for the network to know this correlation information, in order to make MRO analysis properly or avoid a wrong SCG failure type. The reasons are as follows. If the network performs MRO analysis only based on the SPC-report, it may be a too late PSCell change, e.g., the type of SCG failure is too late PSCell change. If the network performs MRO analysis based on related SPC-report and SCG failure information, it may be a PSCell change to a wrong cell, e.g., the type of SCG failure is PSCell change to a wrong cell. Based on different SCG failure types, the network may adopt different PSCell change or CPAC parameters for optimization. For Case 1, if the network cannot correlate the SPC-report and SCG failure information to the same PSCell change or CPAC procedure, it would modify PSCell change or CPAC parameters twice (e.g., once after receiving SPC-report, and once again after receiving SCG failure information), which may lead to improper optimization.

The embodiments of FIG. 4 aim to solve the above issues for a PSCell change or CPAC procedure. The embodiments of FIG. 4 refer to a MN initiated PSCell change or CPAC procedure. For a MN initiated PSCell change or CPAC procedure, if a triggering condition for logging, generating, or storing SPC-report is met, a UE may log, generate, or store successful PSCell change related information, e.g., in the SPC-report. In the embodiments of FIG. 4, in case of a MN initiated PSCell change or CPAC procedure, timer T310 or T312 triggering threshold for SPC-report (e.g., thresholdPercentageT310 or thresholdPercentageT312) is generated by a MN, and timer T304 triggering threshold for SPC-report (e.g., thresholdPercentageT304) is generated by a target SN. When a MN configures timer T312 related triggering threshold, a single T312 threshold common to all measurement identities/objects is configured to the UE in the configuration for triggering the UE to log, generate, or store successful PSCell change related information (e.g., successPSCellChange-Config IE). There may be following six options of the embodiments of FIG. 4:
(1) Option a: SPC-report shall be generated only when timer T312 associated with a measurement frequency or identity or object associated with the target PSCell meets timer T312 triggering threshold, or when a ratio between a value of elapsed running time of timer T312 related to a measurement frequency or a measurement identity or a measurement object of the target PSCell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312).
(2) Option b: A UE shall log, generate, and/or store SPC-report when any timer T312 which is running for any measurement frequency or identity or object configured to the UE meets timer T312 triggering threshold or when a ratio between a value of elapsed running time of timer T312 related to a measurement frequency or a measurement identity or a measurement object of any cell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312). In the SPC-report, the UE shall include measurement frequency or identity or object of which related measurements had triggered SPC-report due to timer T312, or the cell information (e.g., global cell identity and tracking area code, and/or, PCI and carrier frequency (e.g., ARFCN)) whose associated measurement frequency or identity or object meets the timer T312 triggering threshold.
(3) Option c: SPC-report shall be generated only when elapsed running time of timer T310 related to a measurement frequency or a measurement identity or a measurement object that is associated with the target PSCell is longer than a threshold, or, when a ratio between a value of elapsed running time of timer T310 related to a measurement frequency or a measurement identity or a measurement object of the target PSCell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310).
(4) Option d: A UE shall log, generate, and/or store SPC-report when elapsed running time of any timer T310 related to a measurement frequency or a measurement identity or a measurement object that is configured to the UE is longer than a threshold, or, when a ratio between a value of elapsed running time of timer T310 related to a measurement frequency or a measurement identity or a measurement object of any cell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310). In the SPC-report, the UE shall include measurement frequency or identity or object of which related measurements had triggered SPC-report due to timer T310, or the cell information (e.g., global cell identity and tracking area code, and/or, PCI and carrier frequency (e.g., ARFCN) whose associated measurement frequency or identity or object meets the timer T310 triggering threshold.
(5) Option e: SPC-report shall be generated only when elapsed running time of timer T304 related to the target PSCell is longer than a threshold, or, when a ratio between a value of elapsed running time of timer T304 related to the target PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304).
(6) Option f: A UE shall log, generate, and/or store SPC-report when elapsed running time of any timer T304 related to a candidate PSCell that is configured to the UE is longer than a threshold, or, when a ratio between a value of elapsed running time of timer T304 related to any candidate PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304). In the SPC-report, the UE shall include cell information associated with the candidate PSCell.

For any of Option a-Option f, after a MN receives the information associated with the measurement frequency or identity or object, and/or, cell information as mentioned above in any of Option a-Option f, in SPC-report from the UE if any, the MN may transfer the received information associated with the measurement frequency or identity or object and/or the cell information to a source SN, and/or, the MN may transfer the received information associated with the measurement frequency or identity or object and/or the cell information to a target SN.

FIG. 4 illustrates a flow chart of an exemplary procedure of wireless communications in accordance with some embodiments of the present application. The exemplary procedure 400 refers to a MN initiated PSCell change or CPAC procedure. In the embodiments of FIG. 4, a MN performs a MRO function, e.g., analysis of SCG failure(s) and/or modification(s) for PSCell change or CPAC related configuration(s).

Referring to FIG. 4, UE 401, MN 402 and source SN 403 may function as UE 101, MN 102, and SN 103 as shown in FIG. 1, respectively. Target SN 404 may be a target SN not shown in FIG. 1. In particular, following steps are performed in the exemplary procedure 400.
(1) Step 410A or Step 410B (optional): UE 401 transmits an optional UE capability indication for supporting generating successful PSCell change related information (e.g., SPC-report) to MN 402, e.g., via UECapabilityInformation message, to indicate that logging of successful PSCell change related information by UE 401 is optional even if UE 401 supports a PSCell change or CPAC procedure.
   1) The optional UE capability indication should be transmitted before Step 413, e.g., in Step 410A or 410B.
   2) Specific time instance of transmitting the optional UE capability indication may be varied according to different embodiments. As shown in FIG. 4, in some embodiments, this indication is transmitted in Step 410A before Step 411. In some further embodiments, this indication is transmitted in Step 410B after Step 412 but before Step 413. This indication may also be transmitted at any other time instance before Step 413.
   3) Details of the optional UE capability indication may refer to Embodiment 1 as described above.
(2) Step 411: MN 402 transmits a SN addition request message to target SN 404 or a candidate target SN 404 which manages a candidate PSCell.
(3) Step 412: target SN 404 or a candidate target SN 404 which manages a candidate PSCell transmits a SN addition request acknowledge message to MN 402.
   1) For example, the SN addition request acknowledge message includes configuration(s) relating to a trigger condition for UE 401 for logging, generating, and/or storing information associated with a successful completion of a PSCell change procedure or a CPAC procedure (e.g., SPC related information (e.g., successPSCellChange-Config)).
   2) In an embodiment, configuration(s) relating to a trigger condition for SPC related information (e.g., successPSCellChange-Config) includes at least one of: thresholdPercentageT312, thresholdPercentageT310, or thresholdPercentageT304.
      a) In an example, the trigger condition is that the SPC related information is logged, generated, or stored when elapsed running time of timer T312 related to “a measurement frequency or a measurement identity or a measurement object that is associated with the target PSCell” is longer than a threshold, or, the SPC related information is generated when a ratio between a value of elapsed running time of timer T312 related to a measurement frequency or a measurement identity or a measurement object of the target PSCell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312).
      b) In a further example, the trigger condition is that the SPC related information is logged, generated, or stored when elapsed running time of any timer T312 related to “a measurement frequency or a measurement identity or a measurement object that is configured to UE 401” is longer than a threshold, or, the SPC related information is generated when a ratio between a value of elapsed running time of timer T312 related to a measurement frequency or a measurement identity or a measurement object of any cell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312).
      c) In another example, the trigger condition is that the SPC related information is logged, generated, or stored when elapsed running time of timer T310 related to a measurement frequency or a measurement identity or a measurement object that is associated with the target PSCell is longer than a threshold, or, the SPC related information is generated when a ratio between a value of elapsed running time of timer T310 related to a measurement frequency or a measurement identity or a measurement object of the target PSCell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310).
      d) In another example, the trigger condition is that the SPC related information is logged, generated, or stored when elapsed running time of any timer T310 related to a measurement frequency or a measurement identity or a measurement object that is configured to the UE is longer than a threshold, or, the SPC related information is generated when a ratio between a value of elapsed running time of timer T310 related to a measurement frequency or a measurement identity or a measurement object of any cell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310).
      e) In another example, the trigger condition is that the SPC related information is logged, generated, or stored when elapsed running time of timer T304 related to the target PSCell is longer than a threshold, or, the SPC related information is generated when a ratio between a value of elapsed running time of timer T304 related to the target PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304).
      f) In another example, the trigger condition is that the SPC related information is logged, generated, or stored when elapsed running time of any timer T304 related to a candidate PSCell that is configured to the UE is longer than a threshold, or, the SPC related information is generated when a ratio between a value of elapsed running time of timer T304 related to any candidate PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304).
(4) Step 413: MN 402 transmits an RRC reconfiguration message to UE 401.
   1) For example, the RRC reconfiguration message includes configuration(s) relating to the trigger condition for UE 401 for logging, generating, and/or storing the SPC related information. The configuration(s) relating to the trigger condition for SPC related information (e.g., successPSCellChange-Config) includes at least one of: thresholdPercentageT312, thresholdPercentageT310, or thresholdPercentageT304.
   2) For example, the RRC reconfiguration message also includes configuration(s) for a PSCell change or a CPAC.
(5) Step 414: UE 401 logs, generates or stores information associated with a successful completion of a PSCell change procedure or a CPAC procedure (e.g., 1st information), if the trigger condition is fulfilled. After Step 414, UE 401 sends the information associated with a successful completion of a PSCell change procedure or a CPAC procedure (e.g., 1st information) to the network, e.g., a MN or a target SN.
(6) After Step 414, there may be following four options in different embodiments, i.e., Option (A) to Option (D). In Options (A)-(C), Steps 415, 416, and 417 are performed after Step 414. In Option (D), Steps 415, 415A, 416, 417, and 417A are performed after Step 414.
   1) In Option (A)
      a) In Step 415, UE 401 transmits the 1st information (e.g., SPC-report) to MN 402.
         1) In some embodiments, UE 401 may transmit the 1st information to target SN 404.
         2) In Step 414, UE 401 can include a C-RNTI of a source PSCell and/or a C-RNTI of a target PSCell and/or a C-RNTI of a PCell in the SPC-report. If so, in Step 415, UE 401 can transmit a C-RNTI of a source PSCell and/or a C-RNTI of a target PSCell and/or a C-RNTI of a PCell to MN 402, e.g., via the SPC-report.
      b) In Step 416, in a case that a SCG failure occurs, UE 401 logs, generates, or stores information associated with a SCG failure (e.g., the 2nd information). UE 401 can include C-RNTI of the source PSCell and/or C-RNTI of the target PSCell and/or a C-RNTI of a PCell in the SCG failure information (e.g., the 2nd information).
      c) In Step 417, UE 401 transmits the 2nd information (e.g., SCG failure information) to MN 402. After MN 402 receives the SPC-report and the SCG failure information, based on the same C-RNTI(s), e.g., C-RNTI of source PSCell and/or C-RNTI of target PSCell and/or C-RNTI of PCell, included in the SPC-report and the SCG failure information, MN 402 can correlate the SPC-report with the SCG failure information, e.g., MN 402 can know the SPC-report and the SCG failure information are concerning a same PSCell change procedure or CPAC procedure. For example, if MN 402 identifies that they are associated with the same PSCell change or CPAC procedure, MN 402 can correspondingly modify parameter(s) related to the PSCell change or CPAC procedure.
   2) In Option (B)
      b) In Step 415, UE 401 transmits the 1st information (e.g., SPC-report) to MN 402.
         1) In some embodiments, UE 401 may transmit the 1st information to target SN 404.
         2) In some embodiments, the 1st information (e.g., SPC-report) may include cell information of the source PSCell, cell information of the target PSCell, cause value for successful PSCell change report, and/or measurement result(s) of the UE. For instance, the cell information of the source PSCell or the cell information of the target PSCell can be represented by global cell identity and tracking area code, and/or, PCI and carrier frequency.
         3) In some embodiments, the 1st information (e.g., SPC-report) may further include: a C-RNTI of the source PSCell of the UE; a C-RNTI of the target PSCell of the UE; a C-RNTI of the PCell of the UE; time information related to the 1st information; time information related to the 2nd information; and/or an indication for indicating whether both the 1st information and the 2nd information are associated with the PSCell change procedure or the CPAC procedure.
      c) In Step 416, in a case that a SCG failure occurs, UE 401 logs, generates, or stores information associated with a SCG failure (e.g., the 2nd information). UE 401 can include an indication in the SCG failure information, to indicate that the latest SPC-report if any (e.g., in Step 415) is associated with the same PSCell change or CPAC procedure.
      d) In Step 417, UE 401 transmits the 2nd information (e.g., SCG failure information) to MN 402. After MN 402 receives the SPC-report and the SCG failure information, based on the indication in the SCG failure information, MN 402 can correlate the latest SPC-report with the SCG failure information, e.g., MN 402 can know the SPC-report and the SCG failure information are concerning a same PSCell change procedure or CPAC procedure. For example, if MN 402 identifies that they are associated with the same PSCell change or CPAC procedure, MN 402 can correspondingly modify parameter(s) related to the PSCell change or CPAC procedure.
   3) In Option (C)
      a) In Step 415, UE 401 transmits the 1st information (e.g., SPC-report) to MN 402.
         1) In some embodiments, UE 401 may transmit the 1st information to target SN 404.
         2) For instance, UE 401 can include any of following time information in the 1st information (e.g., SPC-report): absolute timestamp when the SPC-report is generated in Step 414 or transmitted in Step 415; absolute timestamp when receiving an RRC reconfiguration for a PSCell change or a CPAC in Step 413; and/or time elapsed from “the time when receiving the RRC reconfiguration for a PSCell change or a CPAC in Step 413” to “the time when the SPC-report is generated in Step 414 or transmitted in Step 415”.
      b) In Step 416, in a case that a SCG failure occurs, UE 401 logs, generates, and/or stores information associated with a SCG failure (e.g., the 2nd information). For instance, UE 401 can include any of following time information in the SCG failure information:
         1) absolute timestamp when the SCG failure information is generated in Step 416 or transmitted in Step 417;
         2) time elapsed from “the time when receiving the RRC reconfiguration for a PSCell change or a CPAC in Step 413” to “the time when the SCG failure information is generated in Step 416 or transmitted in Step 417”; and/or
         3) time elapsed from “the time when SPC-report is generated in Step 414 or transmitted in Step 415” to “the time when the SCG failure information is generated in Step 416 or transmitted in Step 417”.
      c) In Step 417, UE 401 transmits the 2nd information (e.g., SCG failure information) to MN 402. After MN 402 receives the SPC-report and the SCG failure information, based on the time information included in the SPC-report and the SCG failure information, MN 402 can understand whether the SPC-report and the SCG failure information are for the same PSCell change or CPAC procedure or not (e.g., the time elapsed between these two reports are smaller than a configured threshold). If yes, MN 402 can correspondingly modify parameter(s) related to the PSCell change or CPAC procedure.
   4) In Option (D)
      a) In Step 415, UE 401 transmits the 1st information (e.g., SPC-report) to MN 402.
         1) In some embodiments, UE 401 may transmit the 1st information to target SN 404.
         2) In some embodiments, the 1st information (e.g., SPC-report) may include cell information of the source PSCell, cell information of the target PSCell, cause value for successful PSCell change report, and/or measurement result(s) of the UE. For instance, the cell information of the source PSCell or the cell information of the target PSCell can be represented by global cell identity and tracking area code, and/or, PCI and carrier frequency.
         3) In some embodiments, the 1st information (e.g., SPC-report) may further include: a C-RNTI of the source PSCell of the UE; a C-RNTI of the target PSCell of the UE; a C-RNTI of the PCell of the UE; time information related to the 1st information; time information related to the 2nd information; and/or an indication for indicating whether both the 1st information and the 2nd information are associated with the PSCell change procedure or the CPAC procedure.
      b) In Step 415A, upon receiving the SPC-report, MN 402 starts a timer (e.g., timer duration may equal to Tstore_UE_cntxt).
      c) In Step 416, in a case that a SCG failure occurs, UE 401 logs, generates, and/or stores information associated with a SCG failure (e.g., the 2nd information).
      d) In Step 417, UE 401 transmits the 2nd information (e.g., SCG failure information) to MN 402. If the SCG failure information is received before the timer is expired, MN 402 may stop the timer in Step 417A, and MN 402 can understand that the SPC-report and the SCG failure information are for the same PSCell change or CPAC procedure, and perform a MRO function for parameter(s) related to the PSCell change or CPAC procedure. Otherwise, if the SCG failure information is received after the timer is expired, MN 402 can understand that the SPC-report and the SCG failure information are for different PSCell change or CPAC procedures, and would treat the SPC-report and the SCG failure information separately, e.g., perform modification for parameter(s) related to the PSCell change or CPAC procedure twice separately after receiving the SPC-report and the SCG failure information.
   5) In some embodiments, at least two of Options (A)-(D) may be combined. For example:
      a) In Step 414, UE 401 can include a C-RNTI of a source PSCell and/or a C-RNTI of a target PSCell and/or a C-RNTI of a PCell and/or time information (e.g., at least one of: absolute timestamp when the SPC-report is generated or transmitted, time elapsed from “the time when receiving an RRC message for a PSCell change or CPAC procedure” to “the time when the SPC-report is generated/transmitted”) in the 1st information. Then, UE 401 may send such 1st information to MN 402 in Step 415.
      b) In Step 416, UE 401 can include a C-RNTI of a source PSCell and/or a C-RNTI of a target PSCell and/or a C-RNTI of a PCell and time information (e.g., include at least one of: absolute timestamp when the SCG failure information is generated or transmitted, time elapsed from “the time when receiving an RRC message for a PSCell change or CPAC procedure” to “the time when the SCG failure information is generated or transmitted”, time elapsed from “the time when the SPC-report is generated or transmitted” to “the time when the SCG failure information is generated or transmitted”) in the 2nd information (e.g., SCG failure information). Then, UE 401 may send such 2nd information to MN 402 in Step 417.

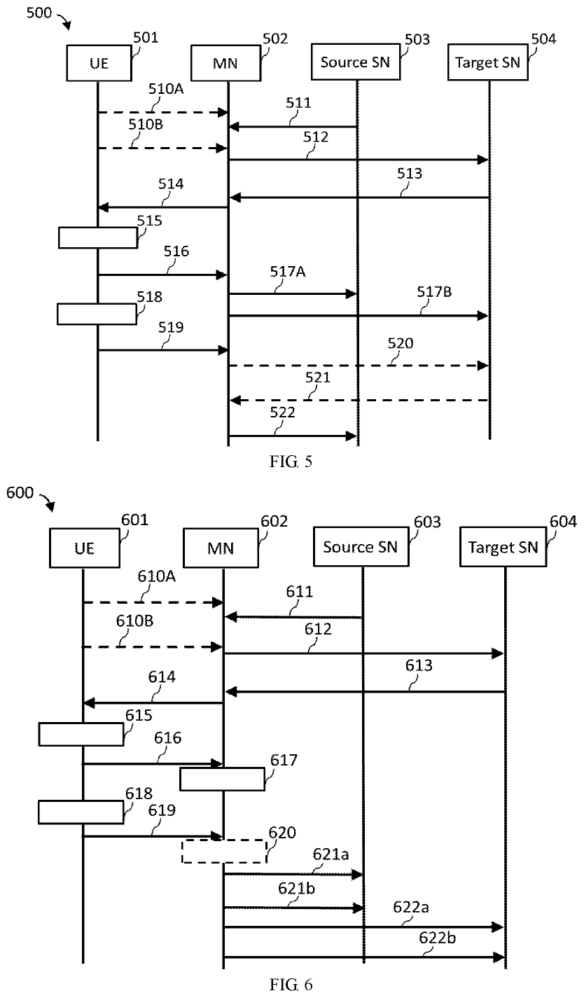

Some other embodiments of the present application, e.g., the embodiments of FIGS. 5 and 6, aim to solve identification issues for a SN initiated PSCell change or CPAC procedure. For a SN initiated PSCell change or CPAC procedure, timer T310 or T312 triggering threshold for SPC-report (e.g., thresholdPercentageT310 or thresholdPercentageT312) is generated by a source SN, and timer T304 triggering threshold for SPC-report (e.g., thresholdPercentageT304) is generated by a target SN.

When a source SN configures timer T312 related triggering threshold, a single timer T312 threshold common to all measurement frequencies or identities or objects may be sent from the source SN to a MN. Then, the MN configures it to the UE in the configuration for triggering the UE to log, generate, or store successful PSCell change related information (e.g., successPSCellChange-Config IE). There may be following six options for a SN initiated PSCell change or CPAC procedure:
(1) Option (1): SPC-report shall be generated only when timer T312 associated with the measurement frequency or identity or object associated with the target PSCell meets timer T312 triggering threshold, or when a ratio between a value of elapsed running time of timer T312 related to a measurement frequency or a measurement identity or a measurement object of the target PSCell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312). In the SPC-report, the UE shall include: information associated with the measurement frequency or identity or object that is associated with the target PSCell, e.g., measurement frequency or identity or object of the target PSCell; and/or cell information associated with the measurement frequency or identity or object that is associated with the target PSCell, e.g., global cell identity and tracking area code, and/or, PCI and carrier frequency (e.g., Absolute Radio Frequency Channel Number (ARFCN)) of the target PSCell.
(2) Option (2): A UE shall log SPC-report when any timer T312 which is running for any measurement identity/object configured to the UE meets timer T312 triggering threshold, or when a ratio between a value of elapsed running time of timer T312 related to a measurement frequency or a measurement identity or a measurement object of any cell and a configured value of the timer T312 (e.g., the configured value of the timer T312 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT312). In the SPC-report, the UE shall include: information associated with the measurement frequency or identity or object that is configured to the UE, e.g., measurement frequency or identity or object of any cell that configured by the network to the UE for RRM measurement; and/or cell information associated with the measurement frequency or identity or object that is configured to the UE, e.g., global cell identity and tracking area code, and/or, PCI and carrier frequency (e.g., Absolute Radio Frequency Channel Number (ARFCN)) of any cell that configured by the network to the UE for RRM measurement
(3) Option (3): SPC-report shall be generated only when elapsed running time of timer T310 related to a measurement frequency or a measurement identity or a measurement object that is associated with the target PSCell is longer than a threshold, or, when a ratio between a value of elapsed running time of timer T310 related to a measurement frequency or a measurement identity or a measurement object of the target PSCell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310). In the SPC-report, the UE shall include: information associated with the measurement frequency or identity or object that is associated with the target PSCell, e.g., measurement frequency or identity or object of the target PSCell; and/or cell information associated with the measurement frequency or identity or object that is associated with the target PSCell, e.g., global cell identity and tracking area code, and/or, PCI and carrier frequency (e.g., Absolute Radio Frequency Channel Number (ARFCN)) of the target PSCell.
(4) Option (4): A UE shall log SPC-report when elapsed running time of any timer T310 related to a measurement frequency or a measurement identity or a measurement object that is configured to the UE is longer than a threshold, or, when a ratio between a value of elapsed running time of timer T310 related to a measurement frequency or a measurement identity or a measurement object of any cell and a configured value of the timer T310 (e.g., the configured value of the timer T310 is configured while the UE was connected to the source PSCell before executing the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT310). In the SPC-report, the UE shall include: information associated with the measurement frequency or identity or object that is configured to the UE, e.g., measurement frequency or identity or object of any cell that configured by the network to the UE for RRM measurement; and/or cell information associated with the measurement frequency or identity or object that is configured to the UE, e.g., global cell identity and tracking area code, and/or, PCI and carrier frequency (e.g., Absolute Radio Frequency Channel Number (ARFCN)) of any cell that configured by the network to the UE for RRM measurement.
(5) Option (5): SPC-report shall be generated only when elapsed running time of timer T304 related to the target PSCell is longer than a threshold, or, when a ratio between a value of elapsed running time of timer T304 related to the target PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304). In the SPC-report, the UE shall include cell information associated with the target PSCell.
(6) Option (6): A UE shall log SPC-report when elapsed running time of any timer T304 related to a candidate PSCell that is configured to the UE is longer than a threshold, or, when a ratio between a value of elapsed running time of timer T304 related to any candidate PSCell and a configured value of the timer T304 (e.g., the configured value of the timer T304 is configured in the RRC message for the last PSCell change or CPAC procedure) is longer than a threshold (e.g., the threshold is included in the configuration, e.g., successPSCellChange-Config configured by the PCell or source PSCell before executing the last PSCell change or CPAC, it can be named as thresholdPercentageT304). In the SPC-report, the UE shall include cell information associated with the candidate PSCell.

In the embodiments of FIGS. 5 and 6, a MN can transfer SPC-report to a source SN and/or a target SN. For example, if SPC-report is triggered due to timer T310 or T312, the MN may transfer SPC-report to the source SN. If SPC-report is triggered due to timer T304, the MN may transfer SPC-report to the target SN.

FIG. 5 illustrates a flow chart of an exemplary procedure of wireless communications in accordance with some embodiments of the present application. The exemplary procedure 500 refers to a SN initiated PSCell change or CPAC procedure. In the embodiments of FIG. 5, source SN performs a MRO function, e.g., analysis of SCG failure(s) and/or modification(s) for PSCell change or CPAC related configuration(s).

Referring to FIG. 5, UE 501, MN 502 and source SN 503 may function as UE 101, MN 102, and SN 103 as shown in FIG. 1, respectively. Target SN 504 may be a target SN not shown in FIG. 1. In particular, following steps are performed in the exemplary procedure 500.
(1) Details of Steps 510A and 510B are the same as those of Steps 410A and 410B in exemplary procedure 400 as shown in FIG. 4, respectively.
(2) Step 511: before Step 512, source SN 503 transmits a SN change required message to MN 502.
   1) For example, the SN change required message includes a container for identification (e.g., PSCell Change Mobility Information), in order to enable later identification and correlation (details are described in Steps 517A, 517B, 520, 521, and 522).
(3) Details of Steps 512, 513, and 514 are the same as those of Steps 411, 412, and 413 in exemplary procedure 400 as shown in FIG. 4, respectively.
(4) After Step 514, there may be following two options in different embodiments, i.e., Option (E) to Option (F).
   1) In Option (E): Steps 515 to 522 are performed after Step 514.
      a) In Step 515, UE 501 logs, generates or stores information associated with a successful completion of a PSCell change procedure or a CPAC procedure (e.g., 1st information), if the trigger condition is fulfilled.
         (1) In one example, in Step 515, UE 501 can include a C-RNTI of a source PSCell and/or a C-RNTI of a target PSCell and/or a C-RNTI of a PCell in the SPC-report. If so, in Step 516, the UE can transmit a C-RNTI of a source PSCell and/or a C-RNTI of a target PSCell and/or a C-RNTI of a PCell to MN 502, e.g., via the SPC-report.
         (2) In another example, in Step 515, UE 501 does not include a C-RNTI of a source PSCell and/or a C-RNTI of a target PSCell and/or a C-RNTI of a PCell in the SPC-report. If so, in Step 516, the UE does not transmit a C-RNTI of a source PSCell and/or a C-RNTI of a target PSCell and/or a C-RNTI of a PCell to MN 502, e.g., via the SPC-report.
      b) In Step 516, UE 501 transmits the 1st information (e.g., SPC-report) to MN 502.
      c) Step 517A and 517B: after MN 502 receives the SPC-report via Step 516, MN 502 transfer the SPC-report to source SN 503 in Step 517A and/or target SN 504 in Step 517B, e.g., via a new defined X2/Xn message (e.g., SPC-Report Transfer message). For instance, MN 502 transfer at least one C-RNTI, at least one ID of UE 501, and/or a container for identification to source SN 503 in Step 517A and/or target SN 504 in Step 517B, e.g., the SPC-Report Transfer message may include at least one C-RNTI, at least one ID of UE 501, and/or a container for identification.
         (1) In some embodiments, MN 502 can send at least one of the following to source SN 503 and/or target SN 504 when transferring the SPC-report: a C-RNTI of a source PSCell of UE 501; a C-RNTI of a target PSCell of UE 501; a C-RNTI of a PCell of UE 501; a MN UE XnAP or X2AP ID (e.g., when a C-RNTI is or is not reported by UE 501); a SN UE XnAP or X2AP ID allocated at source SN 503 (e.g., when a C-RNTI is or is not reported by UE 501); or a SN UE XnAP or X2AP ID allocated at target SN 504 (e.g., when a C-RNTI is or is not reported by UE 501).
      d) In Step 518: in a case that a SCG failure occurs, UE 501 logs, generates, stores information associated with a SCG failure (e.g., the 2nd information).
      e) In Step 519, UE 501 transmits the 2nd information (e.g., SCG failure information) to MN 502.
         (1) In one example, in Step 518, UE 501 can include a C-RNTI of a source PSCell and/or a C-RNTI of a target PSCell and/or a C-RNTI of a PCell in the 2nd information (e.g., SCG failure information). If so, in Step 519, the UE can transmit a C-RNTI of a source PSCell and/or a C-RNTI of a target PSCell and/or a C-RNTI of a PCell to MN 502, e.g., via the SCG failure information message.
         (2) In another example, in Step 518, UE 501 does not include a C-RNTI of a source PSCell and/or a C-RNTI of a target PSCell and/or a C-RNTI of a PCell in the 2nd information (e.g., SCG failure information). If so, in Step 519, the UE does not transmit a C-RNTI of a source PSCell and/or a C-RNTI of a target PSCell and/or a C-RNTI of a PCell to MN 502, e.g., via the SCG failure information message.
      f) Step 520 and Step 521 (optional): after MN 502 receives the SCG failure information, MN 502 may send at least one of: a MN UE XnAP or X2AP ID, a SN UE XnAP or X2AP ID allocated at source SN 503, and a SN UE XnAP or X2AP ID allocated at target SN 504 to target SN 504 in Step 520 (e.g., via a SCG failure information report message). Then, in Step 521, target SN 504 may transmit a SCG failure transfer message to MN 502.
         In some embodiments, the SCG failure information report message and/or the SCG failure transfer message may include a C-RNTI of a source PSCell and/or a C-RNTI of a target PSCell and/or a C-RNTI of a PCell and/or a container for identification.
         For instance, in Step 520, MN 502 can send a C-RNTI of a source PSCell of UE 501, and/or a C-RNTI of a target PSCell of UE 501, and/or a C-RNTI of a PCell to target SN 504.
      g) In Step 522, after Step 519 or Step 521, MN 502 can send a MN UE XnAP or X2AP ID, a SN UE XnAP or X2AP ID allocated at source SN 503, and/or a SN UE XnAP or X2AP ID allocated at target SN 504 to source SN 503 (e.g., via a SCG failure information report message), to source SN 503.
         In some embodiments, MN 502 can also send a C-RNTI of a source PSCell, a C-RNTI of a target PSCell, and/or a C-RNTI of a PCell to source SN 503 in Step 522.
         Based on the C-RNTI(s) and/or UE XnAP or X2AP ID(s), source SN 503 can correlate the SPC-report with the SCG failure information, e.g., identify whether the SPC-report and the SCG failure information are associated with a same PSCell change procedure or CPAC procedure. For example, if source SN 503 identifies that they are associated with the same PSCell change or CPAC procedure, source SN 503 may correspondingly modify parameter(s) related to the PSCell change or CPAC procedure.
   2) In Option (F): Steps 515 to 522 are performed after Step 514.
      a) In Step 515, UE 501 logs, generates or stores information associated with a successful completion of a PSCell change procedure or a CPAC procedure (e.g., 1st information), if the trigger condition is fulfilled. In one example, in Step 515, UE 501 may include time information in the 1st information, e.g., including at least one of: absolute timestamp when the SPC-report is generated or transmitted, time elapsed from “the time when receiving an RRC message for a PSCell change or CPAC procedure” to “the time when the SPC-report is generated/transmitted”.
      b) In Step 516, UE 501 may send the 1st information including the time information to MN 502.
      c) In Step 517A or 517B, MN 502 may send the time information to source SN 503 and/or target SN 504, e.g., include at least one of: absolute timestamp when the SPC-report is generated or transmitted, time elapsed from “the time when receiving an RRC message for a PSCell change or CPAC procedure” to “the time when the SPC-report is generated/transmitted”.
      d) In Step 518: in a case that a SCG failure occurs, UE 501 logs, generates, stores information associated with a SCG failure (e.g., the 2nd information). In one example, in Step 518, UE 501 may include time information in the 2nd information, e.g., include at least one of: absolute timestamp when the SCG failure information is generated or transmitted, time elapsed from “the time when receiving an RRC message for a PSCell change or CPAC procedure” to “the time when the SCG failure information is generated or transmitted”, time elapsed from “the time when the SPC-report is generated or transmitted” to “the time when the SCG failure information is generated or transmitted”.
      e) In Step 519, UE 501 transmits the 2nd information (e.g., SCG failure information) including the time information to MN 502.
      f) In Step 520 or 522, MN 502 may send the 2nd information including the time information to source SN 503 and/or target SN 504, e.g., include at least one of: absolute timestamp when the SCG failure information is generated or transmitted, time elapsed from “the time when receiving an RRC message for a PSCell change or CPAC procedure” to “the time when the SCG failure information is generated or transmitted”, time elapsed from “the time when the SPC-report is generated or transmitted” to “the time when the SCG failure information is generated or transmitted”.
      g) Based on the received time information in Steps 517A and 522, source SN 503 can identify whether the SPC-report and the SCG failure information are for the same PSCell change or CPAC procedure or not. For example, if the time elapsed between these two reports are smaller than a configured threshold, source SN 503 may identify that the SPC-report and the SCG failure information are for the same PSCell change or CPAC procedure. Then, source SN 503 may correspondingly modify parameter(s) related to the PSCell change or CPAC procedure.
   3) In some embodiments, Option (E) and Option (F) may be combined. For example:
      a) In Step 515, UE 501 can include a C-RNTI of a source PSCell and/or a C-RNTI of a target PSCell and/or a C-RNTI of a PCell and/or time information (e.g., at least one of: absolute timestamp when the SPC-report is generated or transmitted, time elapsed from “the time when receiving an RRC message for a PSCell change or CPAC procedure” to “the time when the SPC-report is generated/transmitted”) in the 1st information. Then, UE 501 may send such 1st information to MN 502 in Step 516 and MN 502 send corresponding information to source SN 503 and/or target SN 504 in Step 517A or 517B.
      b) In Step 518, UE 501 can include a C-RNTI of a source PSCell and/or a C-RNTI of a target PSCell and/or a C-RNTI of a PCell and time information (e.g., include at least one of: absolute timestamp when the SCG failure information is generated or transmitted, time elapsed from “the time when receiving an RRC message for a PSCell change or CPAC procedure” to “the time when the SCG failure information is generated or transmitted”, time elapsed from “the time when the SPC-report is generated or transmitted” to “the time when the SCG failure information is generated or transmitted”) in the 2nd information (e.g., SCG failure information). Then, UE 501 may send such 2nd information to MN 502 in Step 519 and MN 502 send corresponding information to source SN 503 and/or target SN 504 in Steps 520-522.
   4) In Option (E) and/or Option (F), in some embodiments, UE 501′s context (e.g., source PSCell related UE context or UE context associated with PSCell change or CPAC) is released in source SN 503 when MN 502 transfers the SPC-report (e.g., 1st information) and/or the SCG failure information (e.g., 2nd information) to source SN 503 and/or target SN 504, i.e., a UE XnAP or X2AP IDs and C-RNTIs are not available for identification.
      a) In an embodiment, to enable source SN 503 to identify the PSCell change or CPAC related information (e.g., the SPC-report initially sent from UE 501, and the SCG failure information initially sent from UE 501) and correlate the SPC-report with the SCG failure information, MN 502 can send one container (e.g., PSCell Change Mobility Information) to source SN 503 and/or target SN 504, e.g., via a new defined Xn/X2 message (e.g., SPC-Report Transfer message), and via a SCG FAILURE INFORMATION REPORT message. Based on the container (e.g., PSCell Change Mobility Information), source SN 503 can correlate the received SPC-report with the received SCG failure information, and modify parameter(s) related to the PSCell change or CPAC procedure.
      b) For example, the container (e.g., PSCell Change Mobility Information) is provided or generated by source SN 503. In a specific implementation, it may be a container (or an index) which is used to map or match with source PSCell related UE context or UE context associated with PSCell change or CPAC, e.g., parameter(s) for the PSCell change or CPAC procedure. For instance, source SN 503 may send the PSCell Change Mobility Information to MN 502 in a S-NODE CHANGE REQUIRED message (e.g., in Step 511), in order to enable later identification and correlation.

FIG. 6 illustrates a flow chart of an exemplary procedure of wireless communications in accordance with some embodiments of the present application. The exemplary procedure 600 refers to a SN initiated PSCell change or CPAC procedure. Referring to FIG. 6, UE 601, MN 602 and source SN 603 may function as UE 101, MN 102, and SN 103 as shown in FIG. 1, respectively. Target SN 604 may be a target SN not shown in FIG. 1. In particular, following steps are performed in the exemplary procedure 600.
(1) Details of Steps 610A, 610B, and 611-614 are the same as those of Steps 510A, 510B, and 511-514 in exemplary procedure 500 as shown in FIG. 5, respectively.
(2) Details of Steps 615 and 616 are the same as those of Steps 414 and 415 in exemplary procedure 400 as shown in FIG. 4, respectively.
(3) Step 617: After MN 602 receives the SPC-report from UE 601, MN 602 starts a timer (e.g., the timer length may equal to Tstore_UE_cntxt).
(4) Details of Steps 618 and 619 are the same as those of Steps 416 and 417 in exemplary procedure 400 as shown in FIG. 4, respectively.
(5) Steps 620-622:
   1) If the SCG failure information from UE 601 is received before the timer is expired, MN 602 can understand that the SPC-report and the SCG failure information are for the same PSCell change procedure. Then, MN 602 may stop the timer in Step 620. For example, MN 602 may use one message to send the received SPC-report and the SCG failure information from UE 601 to source SN 603 in Step 621, and then source SN 603 performs a corresponding MRO function. MN 602 may use one message to send the received SPC-report and the SCG failure information from UE 601 to target SN 604 in Step 622.
      a) In an embodiment, one indication which is used to indicate that the SPC-report and SCG failure information are associated with the same PSCell change or CPAC procedure can be transmitted from MN 602 to source SN 603 in Step 621 and/or target SN 604 in Step 622. Source SN 603 can modify parameter(s) related the PSCell change or CPAC procedure correspondingly based on the received information from MN 602.
   2) Otherwise, if the SCG failure information is received after the timer is expired, MN 602 can understand that the SPC-report and the SCG failure information are for different PSCell change or CPAC procedures, and would treat the SPC-report and the SCG failure information separately. Then, MN 602 may use one message to send the received SPC-report from UE 601 to source SN 603 in Step 621a. MN 602 may use another message to send the received SCG failure information from UE 601 to source SN 603 in Step 621b. Then, source SN 603 preforms MRO analysis and modification for PSCell change or CPAC related parameters after Step 621a as legacy, and source SN 603 preforms MRO analysis and modification for PSCell change or CPAC related parameters after Step 621b as legacy. MN 602 may use one message to send the received SPC-report from UE 601 to target SN 604 in Step 622a. MN 602 may use another message to send the received SCG failure information from UE 601 to target SN 604 in Step 622b.

Details described in all other embodiments of the present application are applicable for the embodiments shown in FIGS. 4-6. It should be appreciated by persons skilled in the art that the sequence of the operations in any of exemplary procedures 400, 500, and 600 in FIGS. 4-6 may be changed and some of the operations in any of exemplary procedures 400, 500, and 600 in FIGS. 4-6 may be eliminated or modified, without departing from the spirit and scope of the disclosure.

Some embodiments of the present application provide a wireless communication apparatus for a PSCell change or CPAC procedure. For example, FIG. 7 illustrates an exemplary block diagram of an apparatus 700 for a PSCell change or CPAC procedure in accordance with some embodiments of the present application.

As shown in FIG. 7, the apparatus 700 may include at least one non-transitory computer-readable medium 702, at least one receiving circuitry 704, at least one transmitting circuitry 706, and at least one processor 708 coupled to the non-transitory computer-readable medium 702, the receiving circuitry 704 and the transmitting circuitry 706. The at least one processor 708 may be a CPU, a DSP, a microprocessor etc. The apparatus 700 may be a network node (e.g., a MN or a source SN) or a UE configured to perform a method illustrated in the above or the like.

Although in this figure, elements such as the at least one processor 708, receiving circuitry 704, and transmitting circuitry 706 are described in the singular, the plural is contemplated unless a limitation to the singular is explicitly stated. In some embodiments of the present application, the receiving circuitry 704 and the transmitting circuitry 706 can be combined into a single device, such as a transceiver. In certain embodiments of the present application, the apparatus 700 may further include an input device, a memory, and/or other components.

In some embodiments of the present application, the non-transitory computer-readable medium 702 may have stored thereon computer-executable instructions to cause a processor to implement the methods with respect to a UE or a network node (e.g., a MN or a source SN) as described or illustrated above. For example, the computer-executable instructions, when executed, cause the processor 708 interacting with receiving circuitry 704 and transmitting circuitry 706, so as to perform the steps with respect to a UE or a network node (e.g., a MN or a source SN) as described or illustrated above.

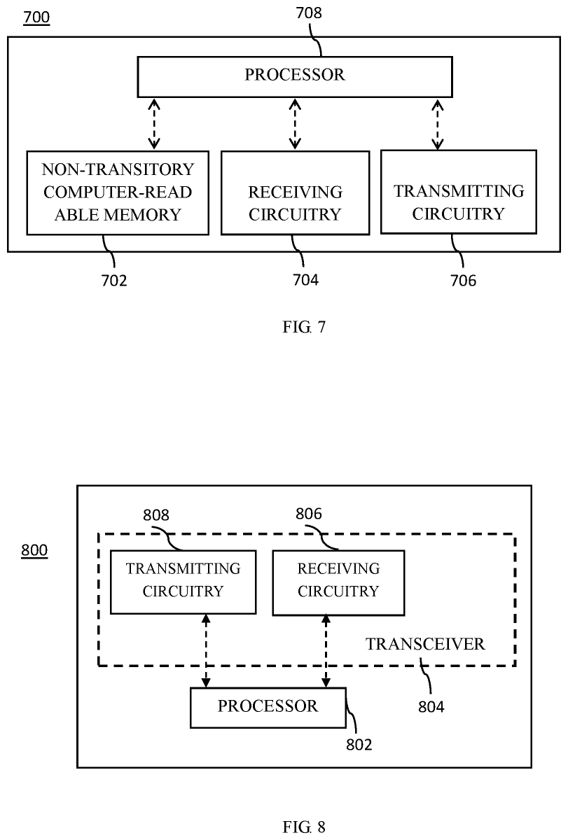

FIG. 8 illustrates a further exemplary block diagram of an apparatus 800 for a PSCell change or CPAC procedure in accordance with some embodiments of the present application. Referring to FIG. 8, the apparatus 800, for example a MN or a source SN or a UE, may include at least one processor 802 and at least one transceiver 804 coupled to the at least one processor 802. The transceiver 804 may include at least one separate receiving circuitry 806 and transmitting circuitry 808, or at least one integrated receiving circuitry 806 and transmitting circuitry 808. The at least one processor 802 may be a CPU, a DSP, a microprocessor etc.

According to some other embodiments of the present application, when the apparatus 800 is a UE, the processor 802 may be configured: in response to fulfilling a trigger condition, to generate information associated with a successful completion of a PSCell change procedure or a CPAC procedure, wherein the UE switches from a source PSCell to a target PSCell during the PSCell change procedure or the CPAC procedure; and to transmit the information via the transceiver 804 to a MN or a target SN which manages the target PSCell.

According to some embodiments of the present application, when the apparatus 800 is a MN, the processor 802 is configured: to transmit an RRC message for a PSCell change procedure or a CPAC procedure via the transceiver 804 to a UE; and to receive information associated with a successful completion of the PSCell change procedure or the CPAC procedure via the transceiver 804 from the UE, wherein the UE switches from a source PSCell to a target PSCell during the PSCell change procedure or the CPAC procedure.

According to some embodiments of the present application, when the apparatus 800 is a source SN, the processor 802 is configured to receive information associated with a successful completion of a PSCell change procedure or a CPAC procedure via the transceiver 804 from a MN, wherein a UE switches from a source PSCell managed by the source SN to a target PSCell during the PSCell change procedure or the CPAC procedure.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
in response to fulfilling a trigger condition, generate first information associated with a successful completion of a primary secondary cell group cell (PSCell) change procedure or a conditional PSCell addition and change (CPAC) procedure, wherein the UE switches from a source PSCell to a target PSCell during the PSCell change procedure or the CPAC procedure; and
transmit the first information via the transceiver to a master node (MN) or a target secondary node (SN) which manages the target PSCell.

2. The UE of claim 1, wherein the at least one processor is configured to cause the UE to transmit an indication for indicating an optional capability for generating the first information via the transceiver to the MN.

3. A master node (MN), comprising:
at least one memory; and
at least one processor coupled with the at least one memory and configured to cause the MN to:
transmit a radio resource control (RRC) message for a primary secondary cell group cell (PSCell) change procedure or a conditional PSCell addition and change (CPAC) procedure via the transceiver to a user equipment (UE); and
receive first information associated with a successful completion of the PSCell change procedure or the CPAC procedure via the transceiver from the UE, wherein the UE switches from a source PSCell to a target PSCell during the PSCell change procedure or the CPAC procedure.

4. The MN of claim 3, wherein:
in response to the first information being generated when a ratio between a value of elapsed running time of timer T312 related to a first measurement frequency or identity or object of the target PSCell and a configured value of the timer T312 is longer than a first threshold, the first information includes at least one of: information associated with the first measurement frequency or identity or object, or cell information associated with the first measurement frequency or identity or object; and
in response to the first information being generated when a ratio between a value of elapsed running time of timer T312 related to a second measurement frequency or identity or object and a configured value of the timer T312 is longer than a second threshold, the first information includes at least one of: information associated with the second measurement frequency or identity or object, or cell information associated with the second measurement frequency or identity or object.

5. The MN of claim 3, wherein the at least one processor is configured to cause the MN to transmit the first information via the transceiver to at least one of: a source secondary node (SN) which manages the source PSCell, or a target SN which manages the target PSCell.

6. The MN of claim 3, wherein the at least one processor is configured to cause the MN to receive second information associated with a secondary cell group (SCG) failure via the transceiver from the UE.

7. The MN of claim 6, wherein the at least one processor is configured to cause the MN to transmit the second information via the transceiver to at least one of: a source secondary node (SN) which manages the source PSCell, or a target SN which manages the target PSCell.

8. The MN of claim 6, wherein at least one of the first information or the second information includes at least one of:
a cell radio network temporary identifier (C-RNTI) of the source PSCell;
a C-RNTI of the target PSCell;
first time information related to the first information;
second time information related to the second information; or
an indication for indicating whether both the first information and the second information are associated with the PSCell change procedure or the CPAC procedure.

9. The MN of claim 6, wherein the at least one processor is configured to cause the MN to identify whether both the first information and the second information are associated with the PSCell change procedure or the CPAC procedure.

10. The MN of claim 9, wherein the at least one processor is configured to cause the MN to:
start a timer in response to receiving the first information; and
identify that that both the first information and the second information are associated with the PSCell change procedure or the CPAC procedure, in response to receiving the second information before an expiry of the timer.

11. The MN of claim 10, wherein, in response to identifying that both the first information and the second information are associated with the PSCell change procedure or the CPAC procedure, the at least one processor is configured to cause the MN to perform at least one of:
modify a set of parameters related to the PSCell change procedure or the CPAC procedure; or
transmit a first message including both the first information and the second information via the transceiver to at least one of: a source secondary node (SN) which manages the source PSCell, or a target SN which manages the target PSCell.

12. The MN of claim 7, wherein the at least one processor is configured to cause the MN to transmit a second message via the transceiver to at least one of: a source secondary node (SN) which manages the source PSCell, or a target SN which manages the target PSCell.

13. The MN of claim 12, wherein the second message includes at least one of:
a cell radio network temporary identifier (C-RNTI) of the source PSCell;
a C-RNTI of the target PSCell;
first time information related to the first information;
second time information related to the second information;
an indication for indicating whether both the first information and the second information are associated with the PSCell change procedure or the CPAC procedure;
an AP ID of the UE allocated at the MN;
an AP ID of the UE allocated at the source SN;
an AP ID of the UE allocated at the target SN; or
an information container used to identify information related to the PSCell change procedure or the CPAC procedure.

14. The MN of claim 3, wherein the at least one processor is configured to cause the MN to receive an indication for indicating an optional capability for generating the first information via the transceiver from the UE.

15. A method performed by a source secondary node (SN), the method comprising:
receiving first information associated with a successful completion of a primary secondary cell group cell (PSCell) change procedure or a conditional PSCell addition and change (CPAC) procedure from a master node (MN), wherein a user equipment (UE) switches from a source PSCell managed by the source SN to a target PSCell during the PSCell change procedure or the CPAC procedure.

16. A method performed by a master node (MN), the method comprising:
transmitting a radio resource control (RRC) message for a primary secondary cell group cell (PSCell) change procedure or a conditional PSCell addition and change (CPAC) procedure via the transceiver to a user equipment (UE); and
receiving first information associated with a successful completion of the PSCell change procedure or the CPAC procedure via the transceiver from the UE, wherein the UE switches from a source PSCell to a target PSCell during the PSCell change procedure or the CPAC procedure.

17. The method of claim 16, wherein:
in response to the first information being generated when a ratio between a value of elapsed running time of timer T312 related to a first measurement frequency or identity or object of the target PSCell and a configured value of the timer T312 is longer than a first threshold, the first information includes at least one of: information associated with the first measurement frequency or identity or object, or cell information associated with the first measurement frequency or identity or object; and
in response to the first information being generated when a ratio between a value of elapsed running time of timer T312 related to a second measurement frequency or identity or object and a configured value of the timer T312 is longer than a second threshold, the first information includes at least one of: information associated with the second measurement frequency or identity or object, or cell information associated with the second measurement frequency or identity or object.

18. The method of claim 17, further comprising transmitting the first information via the transceiver to at least one of: a source secondary node (SN) which manages the source PSCell, or a target SN which manages the target PSCell.

19. The method of claim 17, further comprising receiving second information associated with a secondary cell group (SCG) failure via the transceiver from the UE.

20. The MN of claim 13, wherein the information container is received from the source SN.
